(19) United States
(12) Patent Application Publication
(10) Pub. No.: US 2016/0215718 A1
(43) Pub. Date: Jul. 28, 2016

(54) PREDICTIVE WALL TEMPERATURE MODELING FOR CONTROL OF FUEL DELIVERY AND IGNITION IN INTERNAL COMBUSTION ENGINES

(71) Applicant: Pinnacle Engines, Inc., San Carlos, CA (US)

(72) Inventors: Michael A. Willcox, San Carlos, CA (US); Brede Kolsrud, San Carlos, CA (US); James M. Cleeves, Redwood City, CA (US)

(21) Appl. No.: 15/004,773

(22) Filed: Jan. 22, 2016

Related U.S. Application Data
(60) Provisional application No. 62/107,311, filed on Jan. 23, 2015.
(60) Provisional application No. 62/117,331, filed on Feb. 17, 2015.

(51) Int. Cl. F02D 41/04; F02D 35/02; F02P 5/152

(52) U.S. Cl. CPC F02D 41/04; F02P 5/152; F02D 35/025; F02D 35/027

(57) ABSTRACT

Implementations of the current subject-matter include systems, methods, and techniques that assist with controlling of injected fuel and spark timing across a range of operating conditions. For example, a prediction technique can be used to predict variation in combustion cylinder wall and internal metal temperatures over time, thereby enabling the likely effect of one of the calculated temperatures on airflow and hence on combustion to be assessed. The obtained information can be used to adjust fuel flow or spark timing in accordance with the predicted temperature variation from steady state conditions.

### CROSS REFERENCE TO RELATED APPLICATION

This application claims priority to U.S. Patent Application Ser. No. 62/107,311, entitled “Predictive Wall Temperature Modeling for Control of Fuel Delivery and Ignition in Internal Combustion Engines”, filed on Jan. 23, 2015 and U.S. Patent Application Ser. No. 62/117,331, entitled “Predictive Wall Temperature Modeling for Control of Fuel Delivery and Ignition in Internal Combustion Engines”, filed on Feb. 17, 2015, the disclosures of which are incorporated herein by reference in their entirety.

### TECHNICAL FIELD

The subject matter described herein relates to a system and method of controlling fuel delivery and ignition (spark) timing for operation of an internal combustion engine.

### BACKGROUND

In internal combustion engines, fuel flow is typically mapped in an electronic fuel injection (EFI) system to achieve a desired air/fuel ratio engine at steady-state with a warm engine. A series of tables or “maps” along with a series of modifiers are used by the engine control unit (ECU) to determine and control fuel injected during each cycle across the operating range of speeds and loads. There are typically several modifiers based on data obtained from various sensors for fuel quantity to inject and the timing of the ignition event (spark timing) that should be delivered, which may include ambient pressure, ambient temperature, engine temperature, coolant temperature, startup features, battery voltage, airflow sensors, etc. Normally, a warmup map based on a temperature sensor will address fuel trims required for a cold-to-hot transition. This curve is typically smooth and can correct for airflow differences which arise due to engine temperature affecting the ingested air. Changes in temperature directly affect air density and hence the quantity of oxygen available for combustion, which in turn affects the optimum quantity of fuel which the injector ideally delivers.

An engine temperature sensor may be disposed in liquid such as coolant (e.g. water or oil), or in metal such as a wall or other structure of the air intake. The physical location of this sensor in an engine may not coincide with location(s) that influence airflow. While such sensors can capture steady state characteristics, the temperature at the location of the sensor can result in erroneous fuel trims due its sub-optimal location for the purpose of measuring airflow. Such a sensor may not measure the physical feature that is influencing airflow, for example metal temperatures in contact with the airflow during the induction event. During operation, the engine can have thermal gradients within the metal surfaces that differ from steady-state temperature distributions (for example after a brief, but heavy acceleration from cold). This can cause some surfaces to be colder or warmer than the equilibrium state that is measured by the sensor and used to determine the quantity of fuel to be delivered. Without knowledge of the gradients in metal temperature, the engine fuel system continues to deliver a fixed, mapped mass flow.

In some approaches, the output from an oxygen sensor in the exhaust can be used to mitigate the above-described temperature-detection problem, but an oxygen sensor may not be available in all engine applications. Furthermore, more accurate or immediate fueling variation may be desirable. In these and other circumstances, a more accurate temperature measurement or calculation may be useful.

### SUMMARY

Aspects of the current subject matter can include systems and methods of controlling fuel delivery and ignition (spark) timing for operation of an internal combustion engine. In one aspect, a method of the current subject matter can include determining a hot side temperature boundary condition and a cool side temperature boundary condition for part of a cylinder of an engine. In addition, the method can include mapping the hot side temperature boundary condition for the part of the cylinder to reflect a thermal energy contribution of a combustion event. Additionally, the method can include running a finite element heat transfer model to calculate a first temperature of a first node of a plurality of nodes positioned between the hot side temperature boundary and the cool side temperature boundary. The method can further include compensating, based on the calculated first temperature, one or more engine operation parameters with the compensating resulting in a change to fuel efficiency and/or engine knocking.

In some variations one or more of the following features can optionally be included in any feasible combination. The hot side can include a combustion chamber at least partially contained within the cylinder. The cool side can include one or more of a cylinder block into which heat from the combustion event is dissipated. The cool side boundary condition can be determined using one or more of a direct metal temperature sensor and a liquid temperature sensor. The first node can be located along a cylinder wall of the combustion chamber. The engine operation parameter can include one or more of a spark timing, a quantity of fuel delivered, a throttle position, and a coolant flow rate. The engine operation parameter can include a quantity of fuel delivered to the combustion chamber that is reduced when the first temperature is warmer than a steady state temperature. The engine operation parameter can include a spark advance that is advanced when the first temperature is cooler than a steady state temperature. The engine operation parameter can include a spark advance that is delayed when the first temperature is hotter than a steady state temperature. The finite element model can be one dimensional and arranged radially. The finite element model can account for multiple engine materials. The finite element model can be multi-dimensional, arranged along components of interest, and account for multiple engine materials.

In another aspect, the current subject matter can include an engine having a cylinder and an engine controller including a programmable processor. The engine controller can be configured to perform operations including determining a hot side temperature boundary condition and a cool side temperature boundary condition for part of the cylinder and mapping the hot side temperature boundary condition for the part of the cylinder to reflect a thermal energy contribution of a combustion event. In addition, the performed operations can include running a finite element heat transfer model to calculate a first temperature of a first node of a plurality of nodes positioned between the hot side temperature boundary and the cool side temperature boundary. Additionally, the performed operations can include compensating, based on the calculated first temperature, one or more engine operation parameters with the compensating resulting in a change to fuel efficiency and/or engine knocking. The engine can further include a cylinder block, with the cylinder block including the cool side into which heat from the combustion event is dissipated. The engine can further include one or more of a direct metal temperature sensor and a liquid temperature sensor that determine the cool side temperature boundary condition.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a graphical representation of some engine parameters as they may change in time;

FIG. 2 shows a schematic plan view of an engine, together with a control unit. While spark control is not indicated, it can also be controlled.

FIG. 3 shows a schematic representation of a 1D implementation of the thermal model consistent with one implementation of the current subject matter;

FIG. 4 shows an example of a calculation step consistent with implementations of the current subject matter;

FIG. 5 shows a first section of a calculation process incorporating a calculation as shown in FIG. 4;

FIG. 6 shows a second section of the calculation process shown in FIG. 5;

FIG. 7 shows a schematic representation of an extension of a quasi-2D/dual 1D implementation of the thermal model consistent with an implementation of the current subject matter;

FIG. 8A shows an example cross section of a cylinder wall and the proximity of oil relative to the cylinder wall;

FIG. 8B shows an example 1D finite element grid that can be generated for the cross section shown in FIG. 8A, which can solve various temperatures, including the temperature of the cylinder wall and/or at any of the nodes shown along the cross section;

FIG. 9 shows an example heat flux lookup table, which includes fuel time versus rotations per minute;

FIG. 10 shows an example finite difference model and user inputs;

FIG. 11 shows an example procedure to update temperatures at each node, such as at nodes T1 through T9;

FIG. 12 shows an example matrix form of the procedure shown in FIG. 11;

FIG. 13 shows an example graph that illustrates predicted metal temperatures, actual metal temperatures, and oil temperatures over time; and

FIG. 14 shows a process flow diagram illustrating aspects of a method having one or more features consistent with implementations of the current subject matter.

When practical, similar reference numbers denote similar structures, features, or elements.

### DESCRIPTION

The details of one or more variations of the subject matter described herein are set forth in the accompanying drawings and the description below. Other features and advantages of the subject matter described herein will be apparent from the description and drawings, and from the claims. While certain features of the currently disclosed subject matter may be described for illustrative purposes in relation to a spark-ignited internal combustion engine, it should be readily understood that such features are not intended to be limiting. Implementations of the current subject-matter can, among other possible advantages, provide systems, methods, techniques etc. that can assist with controlling of injected fuel and spark timing across a range of operating conditions and in particular during transient operating conditions. In particular, implementations make use of a prediction technique to predict variation in combustion cylinder wall and internal metal temperatures over time, thereby enabling the likely effect of one of the calculated temperatures on airflow and hence on combustion to be assessed. The obtained information can be used to adjust fuel flow or spark timing in accordance with the predicted temperature variation from steady state conditions.

An engine that is undergoing a rapid load increase (e.g., vehicle acceleration) will have colder initial metal temperatures than would occur if the engine were remaining at that high load indefinitely. These lower metal temperatures may cool the air, thereby resulting in a leaner than optimal mixture due to more air mass being ingested. Alternatively, an engine that is going through a rapid load reduction will be briefly hotter than steady-state conditions (if left at the low load indefinitely) and thus cause a richer-than-optimal mixture due to heating of the air (such that an ingested volume of air will have a lower than optimal mass for a target air-fuel ratio). Such suboptimal fuel delivery can lead to a reduction in fuel economy and/or increase in emissions. These effects can be particularly important in a gasoline engine, in which combustion results can be sensitive to the air-fuel ratio.

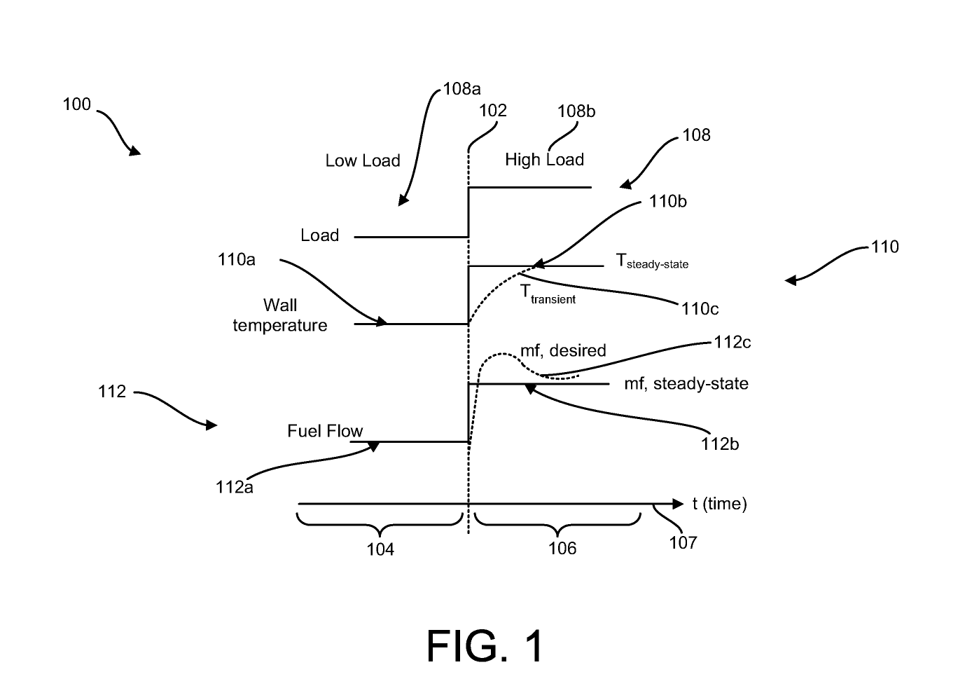

FIG. 1 shows a schematic representation 100 in which there are three graphs indicating variations in load, cylinder wall temperature, and fuel flow in an internal combustion engine. The order of presentation of the graphs is arbitrary. A dotted line 102 indicates a transition point between a low load demand and a high load demand over time. A progression of time is indicated by an x-axis 107 labeled t. The time is shown generally divided into a first portion 104 and a second portion 106, respectively before and after the transition point.

A topmost graph 108 in FIG. 1 shows a step change in load. Thus, for a first portion 108a corresponding to the first time portion 104, the load is steady and lower than that for a second portion 108b, corresponding to the second time portion 106, which is steady but higher.

A second graph 110 indicates cylinder wall temperature. The solid line indicates steady-state temperatures. Thus for a first portion 110a corresponding to the first time portion 104, the temperature is steady and lower than that for a second portion 110b, corresponding to the second time portion 106, which is steady but higher. A dotted line 110c shows a transient load condition in which the cylinder wall temperature rises gradually with time towards the steady-state temperature. This rise may be linear or non-linear.

A lowermost graph 112 indicates desired fuel flowrate. Thus for a first portion 112a the fuel flow is steady and lower than that for a second portion 112b, which is steady but higher. Thus for a first portion 112a, corresponding to the first time portion 104, the temperature is steady and lower than that for a second portion 112b, corresponding to the second time portion 106, which is steady but higher. A dotted line 112c shows a transient load condition in which the fuel flowrate varies with time, eventually reaching a steady-state. This variation is non-linear, having a peak higher than the steady state flowrate shortly after the load demand transients to high and then falling non-linearly to settle at the steady state flowrate.

Implementations of the current subject matter can allow delivery of the above-described non-linear desired fuel flow rate.

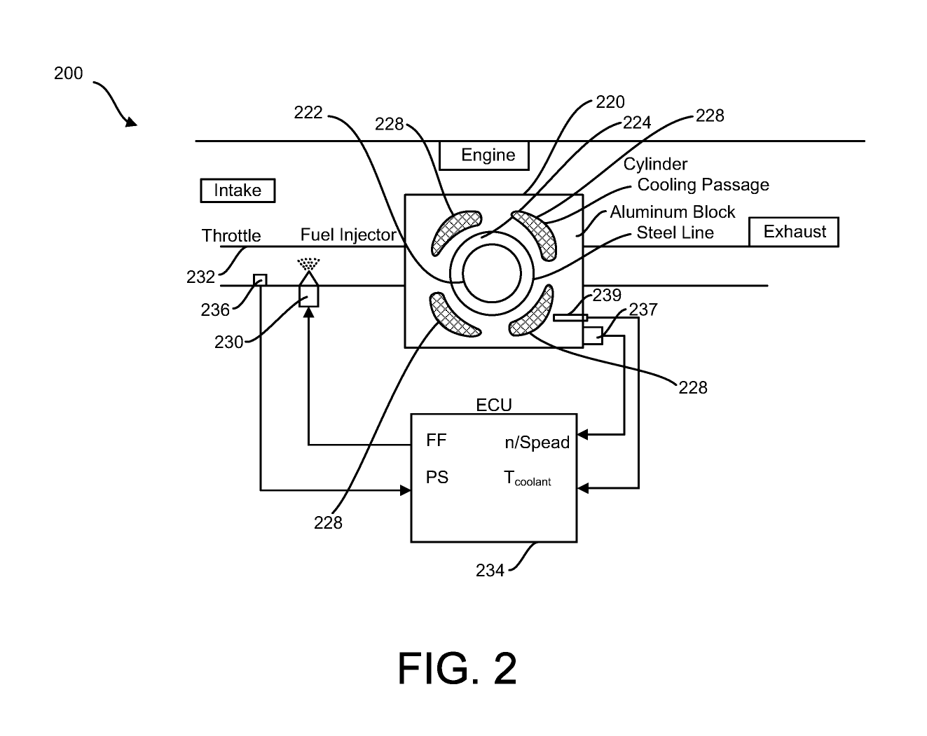

FIG. 2 shows a schematic layout of an internal combustion engine system 200. A cylinder block 220 of the system 200 is shown in plan view. It will be appreciated that the engine may have more than one cylinder within a cylinder block, but a single cylinder 222 is shown for exemplary purposes. An innermost portion of the cylinder block 220 adjacent to a reciprocating piston is a liner 224, which can be made out of steel. Surrounding that is shown a block 226, which can be made out of aluminum. It will be appreciated that in certain applications one or more of a variety of different metals may be used for the liner 224 and/or the block 226. The block 226 can include several cooling passages 228. Four are shown in FIG. 2 for illustrative purposes. During combustion, heat can be transferred between the combustion event and the cylinder block 226, influenced by, among other things, coolant flowing in the cooling passages 228.

The cylinder 222 is shown as being supplied with fuel from a fuel injector 230, downstream of a throttle 232. However, in some implementations a fuel injector can be located upstream of the throttle 232 or even inside the cylinder 222 (e.g. for a direct injection engine). The throttle 232 is controllable by a driver to vary the volume of air delivered to the combustion chamber. In this layout, an engine control unit (ECU) 234 is shown as receiving an input from a pressure sensor 236 (as one means of determining load demand) and as controlling the fuel injector 230 (to deliver a desired fuel quantity). The ECU 234 is also shown as receiving data pertaining to engine speed (from sensor 237) and coolant temperature (from temperature sensor 239) in the cooling passages 228. The ECU 234 can also receive one or more other input parameters.

Knock can be a strong function of internal cylinder wall temperatures that impart heat transfer into the inducted charge, thereby resulting in undesirable auto-ignition of fuel prior to a desired time. This effect can result in abnormal combustion, unpleasant noise, and sometimes hardware failure. One adjustment used in some systems to mitigate knock is to retard the spark timing, which thereby reduces peak cylinder temperatures/pressures and avoids undesirable ignition. Whilst such a measure may mitigate the likelihood of knock occurring, such an adjustment generally results in lower power and/or torque. Often, the spark timing needs to be placed at the worst case fuel/environment/condition set as determined by steady state testing when temperatures have equilibrated. However, drivers/riders may request torque/power rapidly starting from either hotter or cooler engine conditions. For example, starting from a stoplight, a rapid transition to full power would begin with cooler engine temperatures for a period of time, whereas conversely, a quick gear upshift on an acceleration event will pull the engine speed down to a lower power condition and likely result in a brief period of hotter cylinder wall temperatures than steady-state conditions. In these cases, knowing the trend of knock, and hence ignition retard/advance required or permitted as it pertains to the internal cylinder wall temperature, if coupled with information regarding a current cylinder wall temperature, can enable more advanced (or retarded) combustion requirements at full load as appropriate, thereby optimizing power/acceleration whilst reducing the risk of knock.

Inlet port air flow is influenced by heat transfer to the ingested charge based on the metal temperatures that it is in contact with, the time for which that contact occurs, and the heat transfer coefficient (a function of airflow, typically). A more accurate understanding or ECU parameter of the metal temperatures near the inlet (and possibly exhaust) port would enable fuel trims to be more accurate. Thus the quantity of fuel instructed to be delivered by the ECU can be optimized. Some currently available engine control systems use sensors that measure the intake airflow either indirectly (e.g. via a wide or narrow band oxygen (lambda) sensor in the exhaust stream), or directly (e.g. via manifold airflow sensors such as a hot wire anemometer or axial flow fan). However, such systems can be expensive and can therefore be desirable to eliminate. Even if such systems were used, more accurate representation of airflow can enable a more rapid and precise control of the engine under a variety of conditions.

To map even a subset of all possible transient thermal events can require significant computational effort and can further consume memory space on an ECU. Similarly, having additional temperature sensors at various locations in engine structures can add cost to the system.

To address these and potentially other issues with currently available solutions, implementations of the present subject-matter provide systems, methods, articles of manufacture and the like that may improve the ability to predict one or more engine wall temperatures within an internal combustion engine ECU using data available from lower cost sensors that are generally present in existing engine architectures. In other words, in some implementations this prediction may be possible without the use of additional sensors that may not be routinely present in some combustion systems. One or implementations of the current subject matter may allow better prediction of airflow that is ingested, the knock resistance of the mixture, and the required fuel and spark timing, to thereby enable maximization of the efficiency of the ingested charge and optimization of combustion in an engine, especially during transient operations. Here, as in the other mentions in this document, “transient” can mean changing load or speed demand or transient thermal conditions where demand and speed may remain constant while internal metal temperatures are adjusting (e.g. to a change in load, combustion conditions, etc.).

Exemplary methods consistent with implementations of the current subject matter can use a simplified (e.g. one, two, or three dimensional) unsteady (transient) finite element heat transfer model to predict metal temperatures throughout the engine. Some possible desirable temperatures that may be predicted by implementations can include one or more of valve seat and/or cylinder head temperatures, piston crown temperature, inlet port wall temperature, exhaust port wall temperature, and the like.

An engine cylinder wall can be considered to have a “cool side” or “cold side” and a “hot side.” Generally, the hot side is the combustion chamber and the cool side is the metal boundary (e.g. the cylinder block into which heat from the combustion process is dissipated). However, there are times in operation when the combustion side temperatures may be cooler than the “cool” side, in which case the “hot side” and “cool side” are reversed. The definition of hot and cold is used for relative understanding of the layout. Parameters of the cool and hot sides are used as the boundary conditions for finite element analysis (FEA) calculations described below. FEA makes use of numerical techniques to find approximate solutions to boundary value problems. In this case, the solution required is cylinder wall temperature over time, especially during a transient load condition. Possible techniques for determination of the boundary conditions for such a calculation will now be discussed.

A cool side boundary condition can be determined using either a direct metal temperature sensor or a liquid temperature sensor. In the case of a liquid sensor, the ECU can use the measured liquid coolant temperature as the cool boundary condition. The liquid coolant temperature can optionally be an engine oil and/or a water temperature, for example as measured at the point that a cooling fluid flows into or out of the cylinder head or engine block. Using the obtained measurements, coolant (e.g. oil or water) flow rate can be mapped vs. engine speed, or by comparison with a known water pump flow rate curve characteristic. In this manner, the cool side boundary condition can be dynamically controlled by the ECU, based on the measured temperatures.

Hot side (e.g. combustion chamber or port side) boundary conditions can be determined and mapped to reflect a thermal energy contribution to the system for each individual combustion event. Data for mass of fuel injected per cycle can be available to the ECU via a pulse duration or duty cycle demanded to the injector. The injected mass of fuel can be associated with a thermal energy release into the cylinder, and a fraction of the total thermal energy of the fuel entering the metal boundary. This percentage is generally not known as it can vary with engine operating condition (e.g. less thermal energy enters the cylinder boundary when the cylinder wall is at a higher temperature per the first law of thermodynamics). However, consistent with implementations of the present subject matter, the percentage of thermal energy entering the metal boundary can be mapped and input as a parameter to the ECU via uploading as a lookup table or equation. The axis of this lookup table can include, for example, load/speed, pulse width/speed, fuel mass per injection/speed, or the like. Fuel energy can be computed from fuel injected mass and the fuel's chemical energy based on its composition (e.g., lower heating value). Thus the heat flux percentage can be a tuned parameter that is adjusted to match measured temperature information somewhere in the domain being analyzed by the FEA, for example, by a thermocouple embedded in the steel or aluminum at a location in the cylinder wall that matches one of the FEA nodes in the FEA model. In this way, a given percentage, for example 5%, of injected fuel energy can be calculated as heat flux into the system over the 4-stroke or 2-stroke combustion cycle duration based on a finite element analysis using the determined boundary conditions.

The above-described method of calculating hot side boundary conditions may be useful during an acceleration event (e.g. during a transient increase in load demand). However, boundary conditions on the “hot side” can also be required when fuel pulse width is shut off for a deceleration fuel cut (i.e. during operating periods in which no or very little fuel is added to the engine). In this case, use of a fixed fraction of fuel energy may not provide an optimal calculation as the actual net heat flux is most likely to be negative due to heat being passed from the “cool side” (coolant jacket, or engine casting) into the “hot side” (cylinder wall, and into the combustion chamber gasses). In this case, a negative heat flux can be applied as a function of engine speed, which, in some implementations, is mapped by noting the rate of cooling associated with an immediate shutoff of fuel from a known condition. This can be mapped using a temperature sensor physically located within the domain being analyzed, which is disposed to align with one of the thermal nodes of the FEA model. This heat flux parameter may have different units than percent of fuel energy. For example, the heat flux parameter may have units of Joules [J] or an assumed convection coefficient and gas or coolant temperature (e.g. air temperature, or oil temperature as acquired from one or more engine sensors) such that it trends with an amount of heat removal from the hot side boundary.

The temperature or temperatures acquired by the simplified (e.g. as noted above by using a set number of dimensions) FEA model for a specific node, nodes, cell, or cells within the domain can then be used by the ECU as a more accurate estimate of engine temperature distribution and thereby applied to compensate a variety of parameters for actual engine conditions. For example, the model can be used as a primary temperature axis for fuel trims, or in conjunction with other multipliers on the mapped steady-state fuel dosage to deliver additional fuel for an engine that is colder than steady-state (as mapped) and to reduce fuel for an engine that is warmer than steady-state. Additionally, spark timing can be adjusted in knocking regions to impart combustion delay or to impart advance allowed by the near wall temperatures.

Implementations can also be used for an engine that is in a quasi-steady-state but thermal gradients have not yet stabilized and so some surfaces are above or below their true steady-state temperature or the temperature at which its fuel schedule was mapped. For example, a cold engine that has just been started and rapidly moved to a constant load may have a relatively quickly climbing initial wall temperature (∂T/∂t>>0) and a slowly climbing oil temperature (∂T/∂t>0). Eventually equilibrium will be reached. A delta metric can be generated to be used for control system trims on fuel/spark relative to what would be reached if steady state were to be reached. The steady state conditions that would occur if the engine remained at the aforementioned condition indefinitely can immediately be calculated during a transient to quantify this delta.

Implementations of the current subject matter can utilize inputs from some characteristic engine load parameters that are known to the ECU (e.g. VolEff, Fuel Pulse Width, Normalized manifold pressure, Airflow, etc.), together with data from an engine speed sensor (RPM) and a coolant or metal temperature sensor, as shown schematically in FIG. 2. These inputs can be combined in the ECU 234 with a map (vs. RPM and load) for heat flux based on fuel energy that is lost to convective heat transfer through the valve seat or cylinder head as a function of speed and load at steady-state. The following example describes a 1D finite-difference transient thermal model, but alternatively a quasi-2D (dual 1D) or full 2D or 3D FEA model can be used to determine temperatures. For example, in quasi-2D mode, a “T” shaped 1-D mesh can be adopted where one dimension is along the path that heat flux occurs between the cylinder internal surfaces to the coolant jacket (or vice versa) and the other 1D dimension can connect one or more of those nodes to another metal feature, such as the inlet port wall. In this case, an additional boundary condition can be assigned to the air temperature and flow rate to add/remove heat to the thermal mesh. Airflow approximations are known to the ECU, so a convection coefficient for air can be estimated at (for example) VolEffvs. RPM map. Additionally a mapped fraction of injected fuel that vaporizes (e.g. absorbs heat via the latent heat of the fuel) on the port wall can be accounted for using heat of vaporization and mass of fuel injected.

As another example, the FEA node mesh can be connected along multiple paths traversing multiple engine components with the appropriate boundary conditions applied. For example, with temperatures between the coolant jacket and cylinder head predicted, the node mesh can traverse to the valve guide, down the valve stem and valve head. Heat addition/rejection to the valve stem and port surfaces can be estimated with estimations or maps of gas temperatures (inlet and/or exhaust), any fuel vaporization, and the appropriate heat transfer coefficient maps. A thermal contact resistance can be applied for the guide-to-head, guide-to-valve, and valve-to-seat contact points where neighboring nodes within the FEA mesh have the appropriate thermal resistance. The node of the cylinder head can be used as the boundary condition at the end of that particular node mesh. More detailed knowledge of wall temperatures within the ECU can enable calibration parameters and tables to more accurately manage fuel and spark delivery during transients.

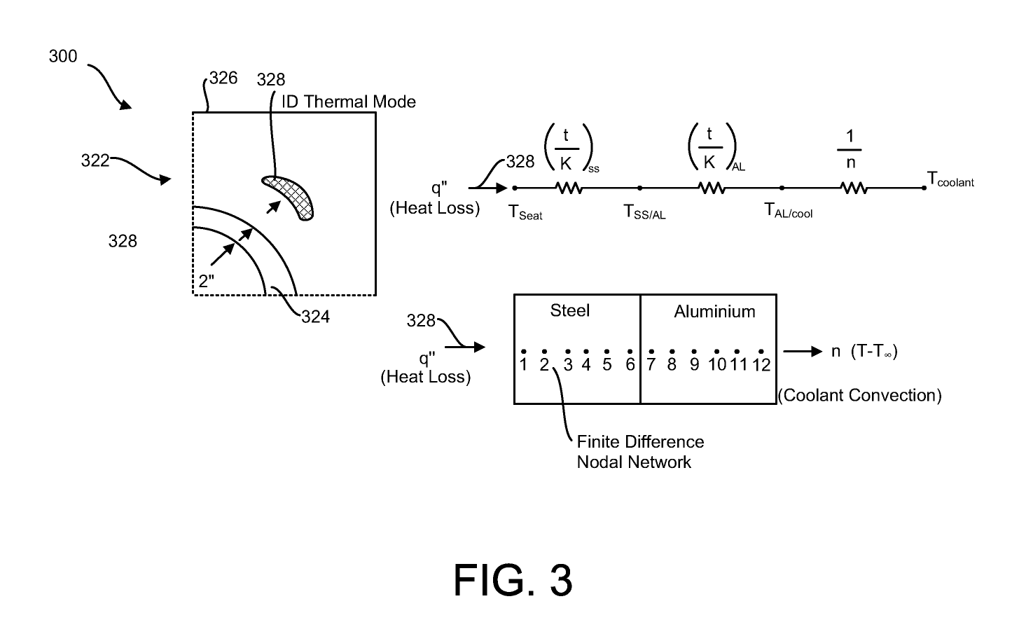

An exemplary 1D thermal model 300 is shown in FIG. 3. Visible in the figure is one quadrant of a cylinder 322, with a corresponding portion of a steel liner 324, surrounded by a corresponding portion of an aluminum block 326, having an exemplary single cooling passage 328. Heat loss from the cylinder is indicated by the symbol q″ and an exemplary 1D heat flow path into the block 326 is indicated by an arrow 338. Between a cylinder wall of the cylinder 322 and coolant in the cooling passage 328, the material properties of the thermal path between the surface of interest (e.g., steel valve seat, aluminum casting, etc.) to the “cool” boundary condition (e.g., coolant or metal where thermistor resides) is built into the ECU to estimate the seat temperature. Model calibration can be done using measured temperature data somewhere along the 1D mesh heat flow path and mapped to match the measured temperature.

The exemplary model is a finite difference model, which combines geometry (e.g., lengths) and differing material properties (e.g., thermal conductivity) between the seat/cylinder wall (Fourier numbers), boundary conditions for heat flux from fuel energy map, and boundary conditions for coolant convection (e.g. Biot numbers and coolant temperature). Boundary conditions were discussed above. The heat loss (or addition if negative) q″ is shown as being derived from the valve seat temperature (Tₛₑₐₜ), the steel-aluminum boundary temperature T_{St/Al} and the aluminum-coolant boundary temperature (T_{Al/cool}). Other parameters include the heat transfer coefficient, h, and a constant, K. The lowermost part of FIG. 3 shows heat loss q″ being computed as a series of finite difference calculations. In some examples, updated seat temperature can be computed as often as boundary conditions are refreshed, for example once per combustion cycle.

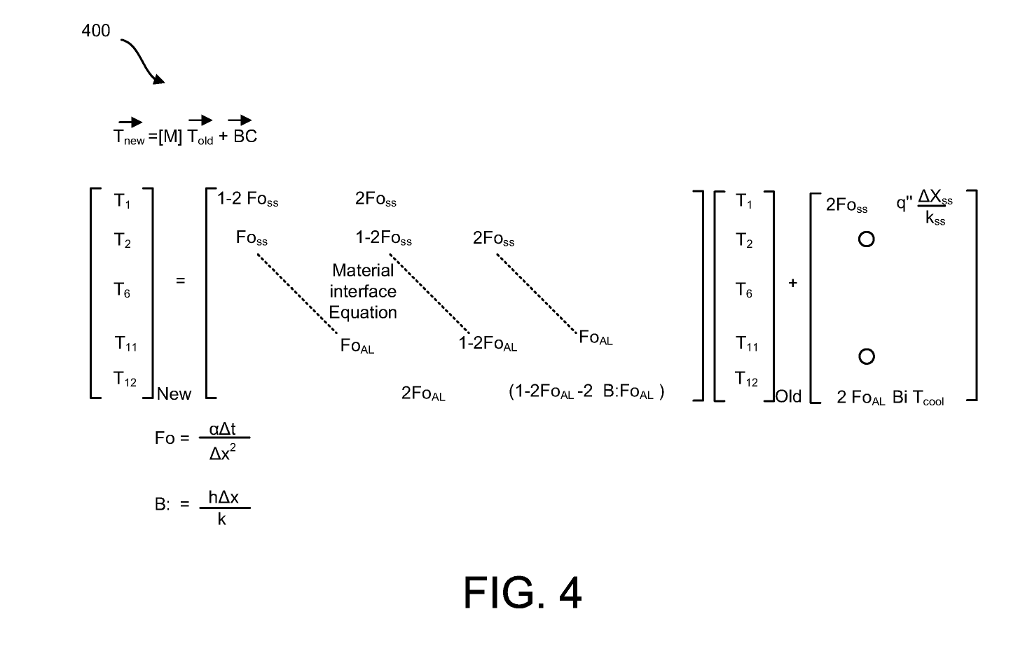

A transient finite-difference scheme consistent with implementations of the current subject matter can be time-marching and may rely only on knowing the last temperature and time step between, Δt. For each difference calculation T_{new}=[M]*T_{old}+BC, where T_{old} is the temperature calculated by the previous difference calculation. FIG. 4 shows an expansion 400 of sequential difference calculations. T_{new} is indicated as incrementing from T1 up by one for each calculation. The matrix M is populated by Fourier numbers Fₒ, which indicate heat conduction through the steel liner 224,324 and the aluminum block 226, 326. As indicated, Fₒ is calculated from the thermal diffusivity α, a ∂t (time difference) and ∂x (discrete node distance through the steel portion and aluminium bock portion that heat is travelling). It should be noted that the type of material and number of materials are freely variable. There can be a single aluminium or steel material, or aluminum to steel to aluminum composition, or any alternative material in sequence with any number of other materials. The matrix M also uses the Biot number, Bᵢ, which is a dimensionless value indicating heat transfer through the coolant. Discretization also does not need to be constant through the different regions of the mesh or materials. Higher or lower resolution can be applied as and where necessary. As indicated, Bᵢ is calculated from h, ∂x and K. The method may be especially beneficial if the update frequency is fixed so that the Fourier numbers are constant (to minimize memory requirements and ensure stability).

As mentioned above, the Biot number for the coolant convection boundary condition is contained in both the [M] matrix and BC vector. For constant material properties and known coolant flow rates based on the pump characteristics, the flow, and hence convection coefficient will be primarily a function of engine speed. For variable material properties, such as oil, the fluid temperature can be used to adjust the convection coefficient along with measured speed.

In further implementations of the current subject matter, an area ratio between the cold-to-hot or hot-to-cold sides can be introduced to enable a user-tunable parameter for improving transient model temperature prediction accuracy. Increasing the area of one side or another in a 1D model essentially multiplies the heat rejected or added to one or the other boundary condition surface. A change of this area can require a different (albeit auto-updated/computed) “base” map for percent heat of fuel energy released into/out of the system to match steady-state temperatures, but will enable transient performance (e.g., model under- or over-predicting temperature rise or fall rates on rapid load changes) to be adjusted if predicted dynamic temperatures do not match measured temperatures. This tunable area ratio can be a fixed value, a function of speed, or a function of load and speed.

Additionally, using knock sensor feedback, the model can learn the ignition advance (and hence relationship to model-predicted seat temperature) that is permissible before audible knock. This can deviate from the as-mapped condition at steady-state due to a variety of reasons including, but not limited to, hardware build variations, environmental conditions, engine deterioration, or fuel properties. There may be a difference in steady-state knock-limited ignition advance that each engine is capable of which would enable higher seat temperatures for a given knock limit than the base map was allowed. In this case, the new seat temperature spark trim table or offset or gain can be learned and used to add/remove spark advance automatically to take advantage of steady-state performance increases for more torque or less knocking noise. For example, an engine operation parameter can include spark advance that is advanced when a determined temperature (e.g., at a node) is cooler than a steady state temperature. The spark advance can also be delayed when the determined temperature (e.g., at a node) is hotter than a steady state temperature.

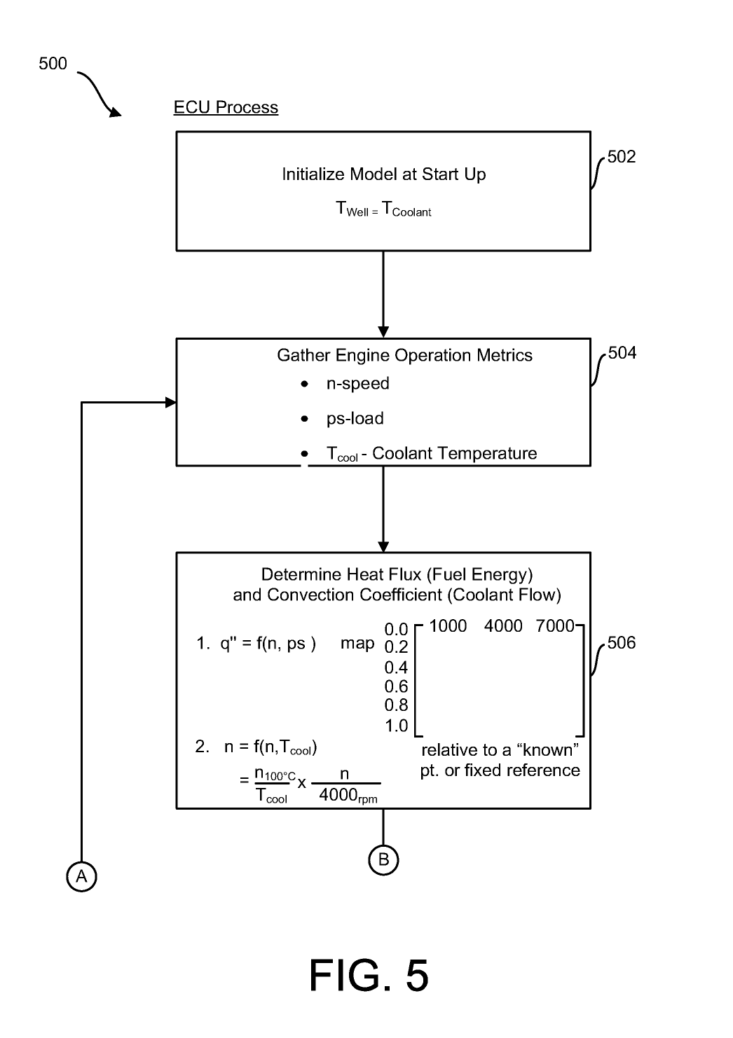

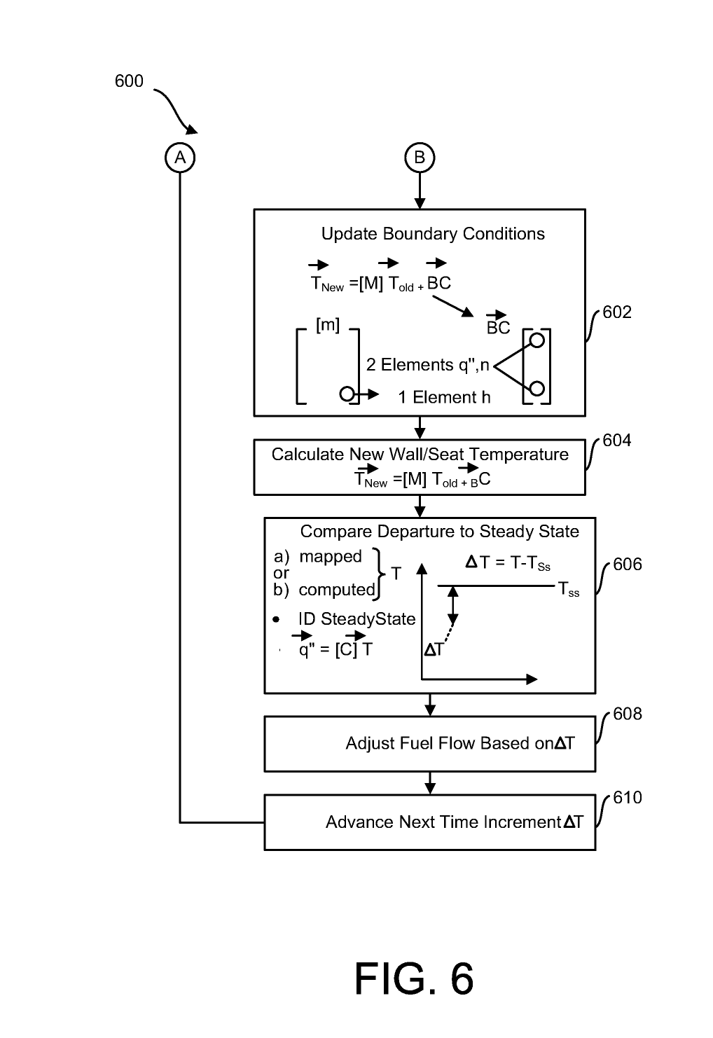

FIGS. 5 and 6 depict features of a process 500 that an ECU 234 consistent with implementations of the current subject matter can execute. The process incorporates the finite difference calculation of FIG. 4. In a first calculation step 502, the model is initialized at a starting point where T_{wall}=T_{coolant}. At 504, the ECU receives engine operating inputs, including speed, intake air pressure (thereby providing a measure of load demand) and coolant temperature (T_{cool}) from an engine.

At 506, a map of heat flux is used to determine heat flux flowing from the combustion process through the cylinder block (or in the reverse direction in the case of dropped load). The heat transfer coefficient, h, can be determined with reference to a known or fixed value thereof. A newly discovered simplification can be implemented that captures the viscosity influence on heat transfer coefficient according to the equation shown. The map may be generated and uploaded to the ECU following creation as discussed above.

At 602, a first iteration of the difference calculation shown in FIG. 4 is performed. The result of the first iteration is then used at 604 to calculate a new wall or valve seat temperature. At 606 the departure of the calculated temperature from an expected steady state temperature, T_{SS}, is determined. At 608, the ECU signals the fuel injector 230 to deliver a quantity of fuel adjusted based on the determined value or departure. The ECU may also signal adjustment of other parameters, such as spark timing.

At 610, ∂t is incremented and the process starts again at 504 for the next time increment. The process can be repeated indefinitely or by some selection criteria as determined by conditions and as many time increments as necessary, for example until the departure from the expected steady state temperature is zero or close to zero.

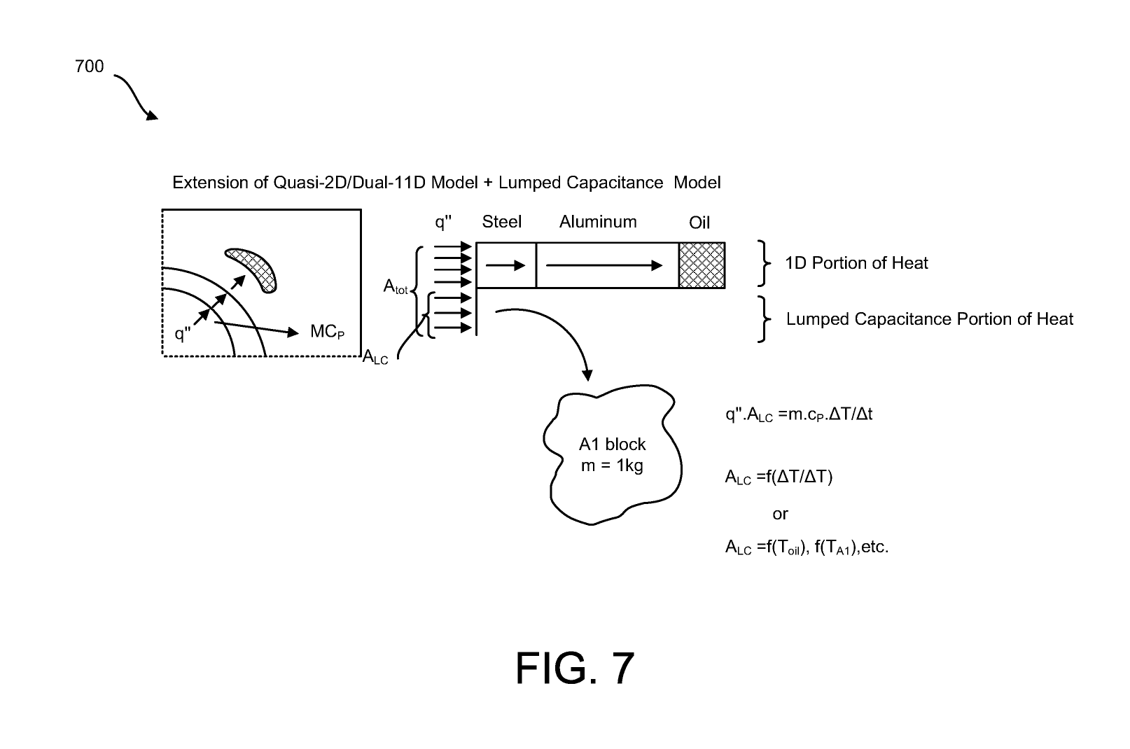

FIG. 7 shows a schematic representation 700 of an extension of a quasi-2D/dual 1D implementation. The extension can include a combination of the 1D model and a lumped-capacitance thermal model. A shared area between the two models, such as for example a valve seat or cylinder wall, can be included in the modeling. Thus, a heat flux from the fuel energy can be applied to the wall and partitioned between the 1D circuit and lumped-capacitance mass depending on the current state of the engine. This area partition can be a function of any or all of oil temperature, engine block temperature, the gradient (dT/dt) of heat up/cool down, the difference in temperature compared to the steady-state temperature at each node, or some combination of these or other factors. Multiple materials with different specific heats can be accounted for where, for example, the nodes that fall inside the steel can reject heat to a steel lumped capacitance mass, and nodes which fall within the aluminum reject heat to an aluminum mass. The thermal mass generally affects only ratio of heat added/removed and so only needs to be updated once per combustion event.

In an example application of this approach, at startup when the engine block is cold, dT/dt of the engine block is typically high. Thus, the effective area (A_{LC}) diverting thermal energy (heat) to the surrounding metal surfaces as they warm up can be high, and the heat passed through to the coolant side would be low. On cool down conditions, the area ratio would work in reverse (e.g., <1.0) enabling the thermal mass to supply energy to the mesh. Near steady-state, the heating or cooling of the block is minimal (dT/dt≈0) so the area (A_{LC}) diverting heat to the block is low and the majority of heat is passed directly through the mesh (e.g., from hot to cold side). The impact of a lumped capacitance thermal model to the x-dimensional node temperatures can then be realized by, for example, adjusting the proportion of the seat/cylinder area (Aₜₒₜ−A_{LC}) to the area of the oil convection passage. Additionally, multiple rejection sources of heat can be added to enable heat to be removed from one or all nodes within the 1D, 2D, or 3D mesh.

In addition, this lumped capacitance mass or masses can include the ability to reject heat to (or absorb heat from) an environment. The heat rejection from the lumped capacitance mass can include terms for one or more of convection, conduction, and radiation. The mass or masses can reject/absorb heat to/from an environment that was either fixed by mapping parameters or variable utilizing various ECU sensor inputs (e.g., inlet air temperature for temperature, vehicle velocity for a trend of convection coefficient, engine radiator fan control, etc). Such an approach can enable the continuation of heat transfer when the engine is turned off as well as a more accurate initial condition set for the nodes upon engine restart.

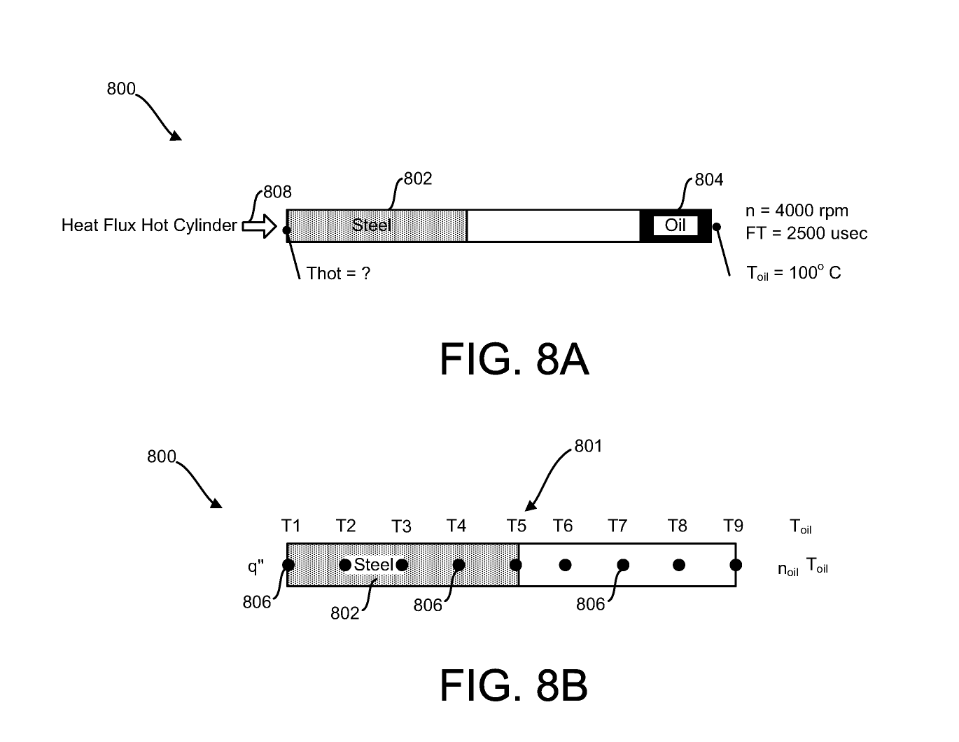

FIG. 8A shows an example cross section 800 of a part of a cylinder block showing the proximity of oil 804 relative to a cylinder wall 802. In addition, the direction 808 of heat flux from a hot cylinder is shown. The subject matter discussed herein allows for the prediction of the cylinder wall temperature based on the temperature of the oil (or similar), engine speed, and fuel flow. As shown in FIG. 8B, a 1D finite element grid 801 can be generated for the cross section 800 in order to solve various temperatures, including the cylinder wall 802 temperature and/or any of the nodes 806 shown along the cross section 800.

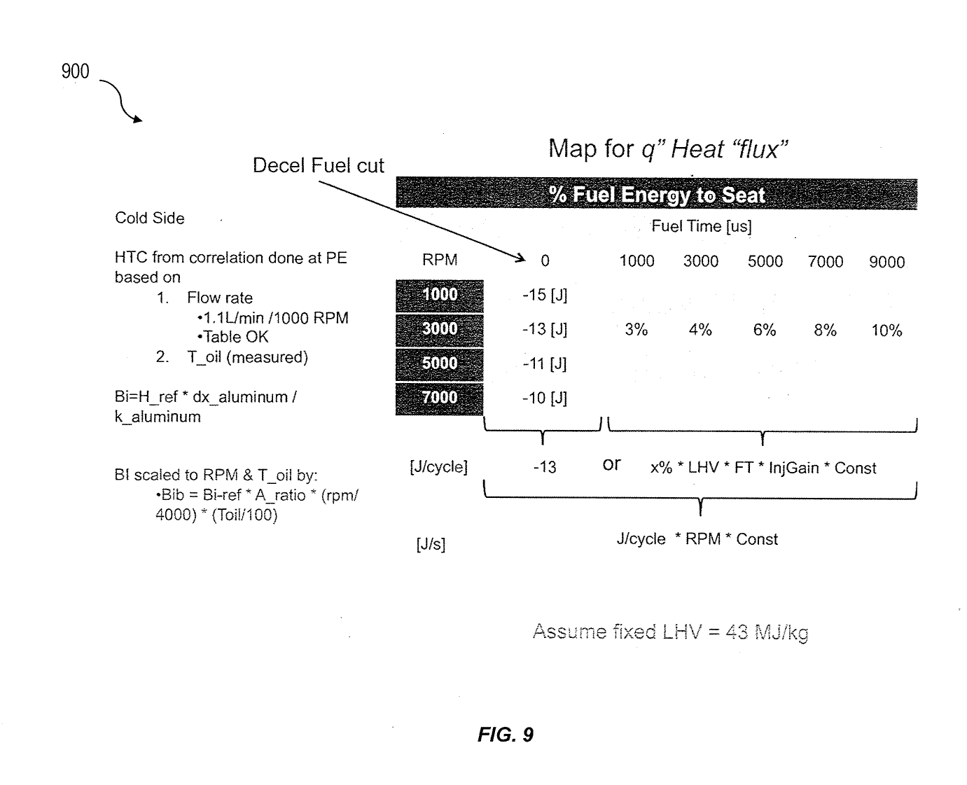

As discussed above, the finite element grid 801 can be used to determine various temperatures along the cross section 800, such as at each node 806. At startup, the temperatures can be initialized at each node 806 (e.g., T1, T2, etc.). The ECU can collect inputs, such as engine speed, fuel time, and oil temperature. New boundary conditions can then be calculated, such as by using a heat flux lookup table, such as shown, for example, in FIG. 9, which includes the fuel time versus rotations per minute of the engine. New temperatures can then be calculated, with every node 806 having its own equation for determining a temperature associated with each node. The above can be repeated, as necessary, for determining temperatures at each node 806 in at least near real-time.

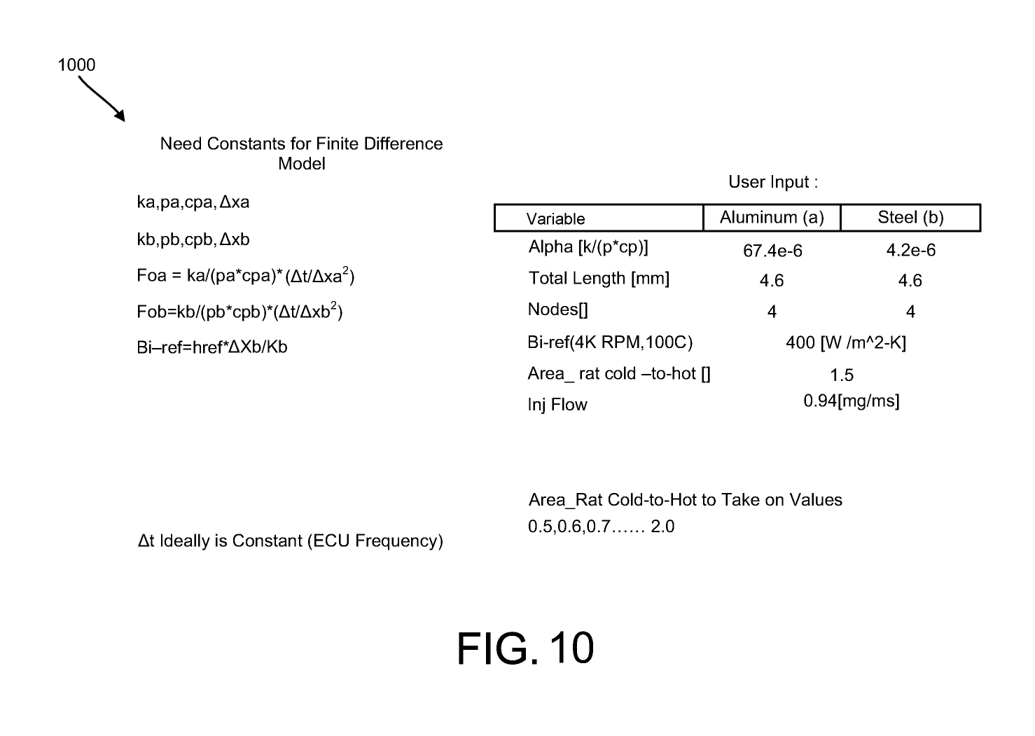

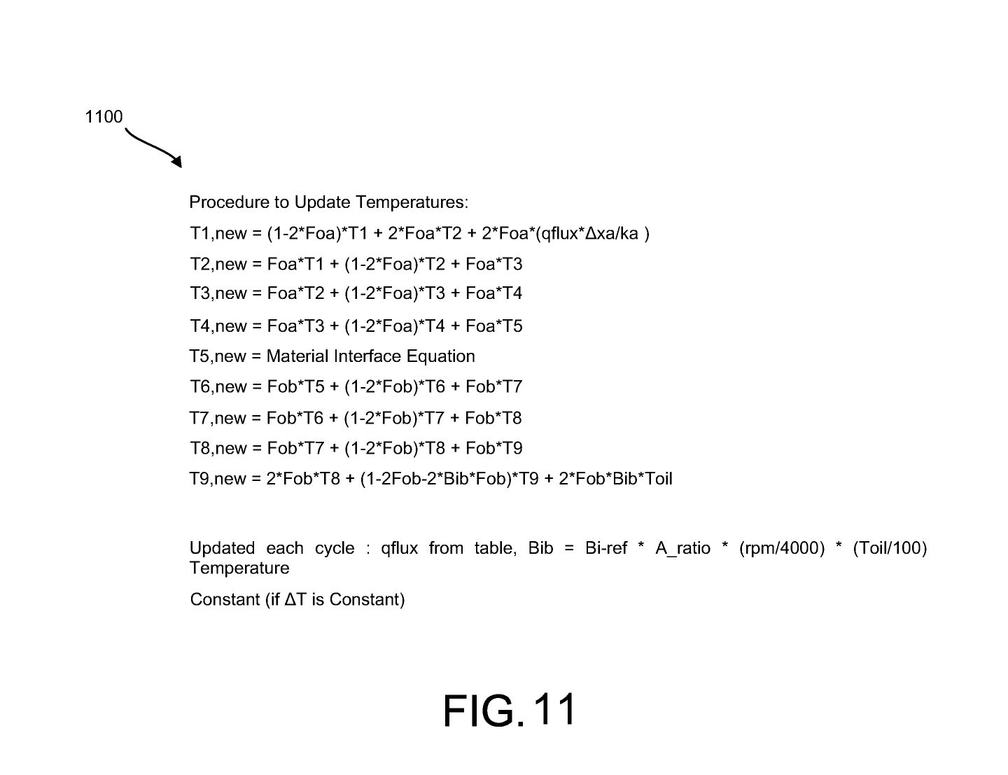

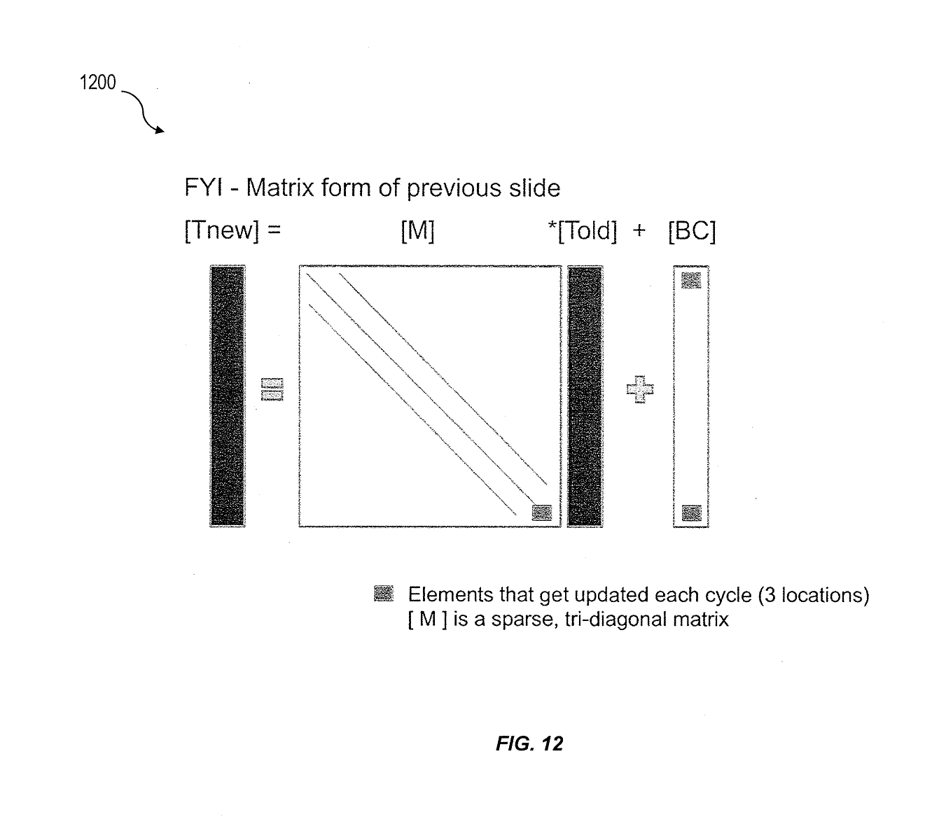

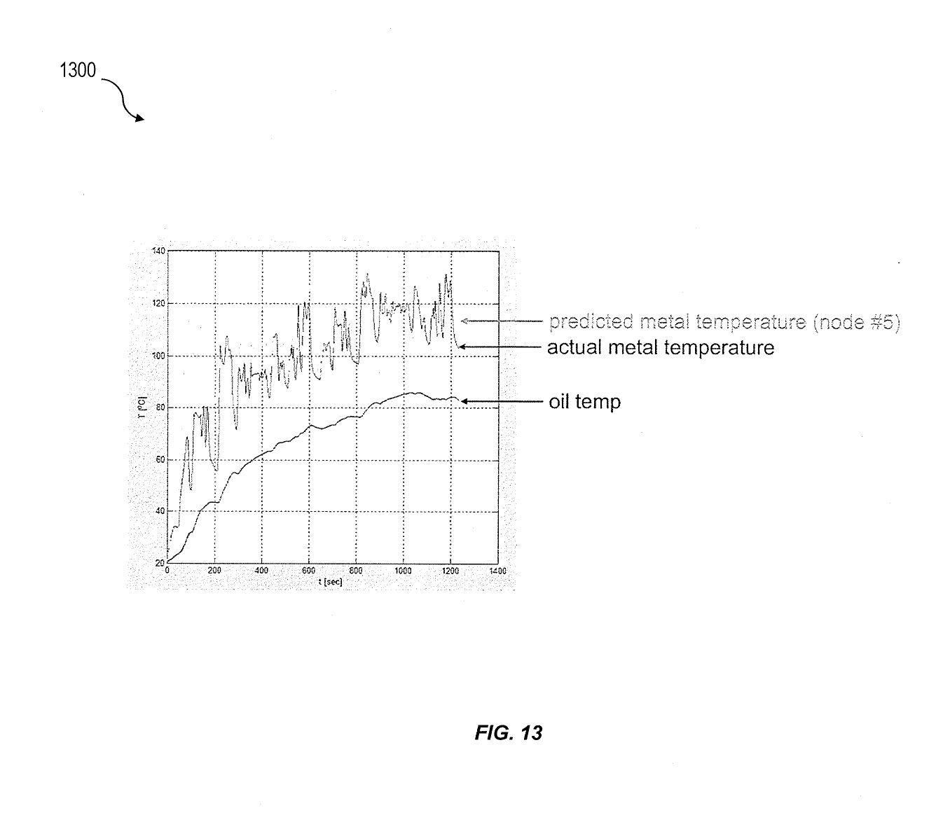

FIG. 10 shows an example finite difference model and user inputs 1000 consistent with the subject matter disclosed herein. FIG. 11 shows an example procedure 1100 to update temperatures at each node, such as at nodes T1 through T9. FIG. 12 shows an example matrix form 1200 of the procedure 1100 shown in FIG. 11. FIG. 13 shows an example graph 1300 that illustrates predicted metal temperatures using methods consistent with the subject matter disclosed herein, actual metal temperatures, and oil temperatures over time.

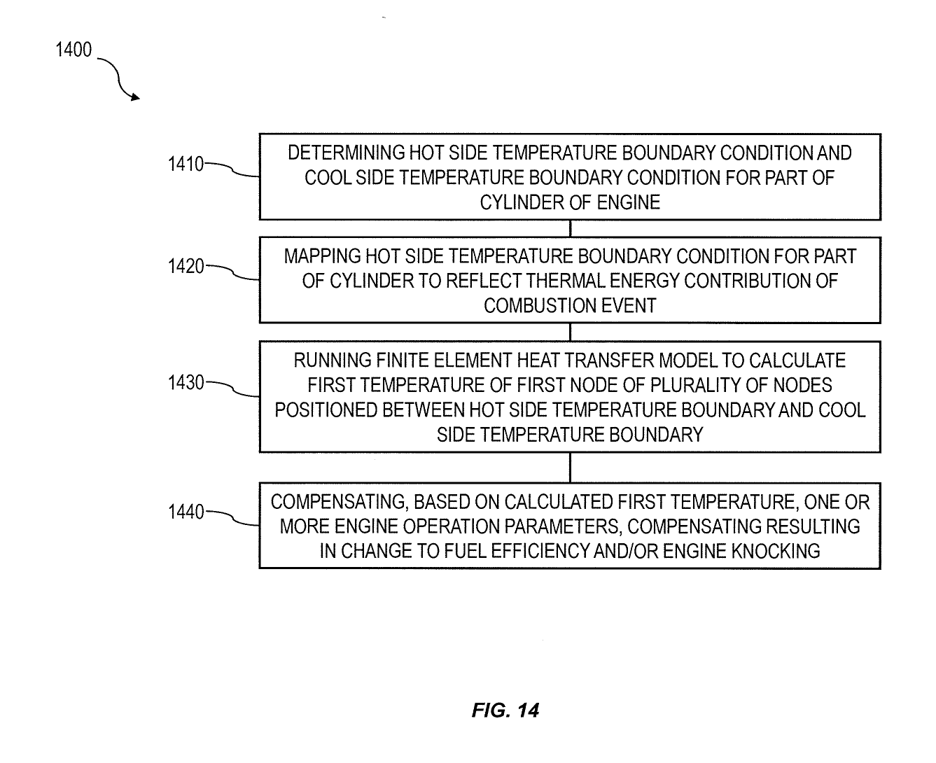

FIG. 14 shows a process flow chart illustrating features than can be present in one or more implementations of the current subject-matter. At 1410, the hot and cool side boundary conditions are determined for a chosen part of the cylinder wall, for example for a valve seat or a piston crown etc. Determination of the boundary conditions has been discussed in more detail above.

At 1420, the hot side temperature boundary condition is mapped for the chosen part of the cylinder wall to reflect the thermal energy contribution of individual combustion events. This process was described in more detail above. The map and the cool side boundary condition are made available to the ECU 234.

At 1430 a simplified finite element (e.g. finite difference model) is run by the ECU to calculate temperature(s) for each of one or more specific nodes into the engine case between the cylinder wall and cold side boundary conditions.

Following running of the model, at 1440 an engine parameter such as fuel quantity is adjusted to compensate for the results obtained by running the model(s). Thus if the temperatures calculated diverge from the expected steady state temperatures, the ECU may signal for one or more parameters to be adjusted, such as fuel quantity to be delivered, spark timing, throttle position if electronically controlled, coolant flow if abnormal combustion. Thus combustion can be optimized to improve fuel efficiency and/or to reduce or eliminate knock.

It will be appreciated that the above-described systems and methods can be used with many different types of internal combustion engines. As the system delivers fuel to an air intake passage, it can be used with single or multiple-cylinder engines of various configurations. There can be individual cylinder-specific trims and/or multiple connected or individual meshes applied in single or multi-cylinder applications. There can be multiple temperature sensors along with multiple connected or independent meshes. Additionally, the heat released to the coolant can be used with an additional mesh inside the coolant itself to model the increase/decrease in temperature from one location in the engine to another. These nodes can be the input boundary conditions for other individual or coupled meshes such that temperature differences within the coolant cavity better reflect the local conditions of the additional metal FEA meshes. It will also be appreciated that various components of carburetion and fuel systems have been omitted from the above-discussed figures to improve clarity, but they can be present in any implementation. For example, the necessary sensors are not shown in many figures, but those skilled in the art will be able to contemplate arrangements for type and positioning of those. Another example can be in an electronic carburetor application where the same method and trims are applied for air bleed or fuel bleed to correct mixture. In addition, solely spark trims can be applied to a fully non-electronic carburetor where no ECU-based fuel control is possible.

Implementations of the current subject matter can include, but are not limited to, articles of manufacture (e.g. apparatuses, systems, etc.), methods of making or use, compositions of matter, or the like consistent with the descriptions provided herein.

Implementations of the current subject matter can include, but are not limited to, methods consistent with the descriptions provided above as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers or devices that act in a client-server relationship. A client and server are generally remote from each other and typically interact through a communication network, which can be wired or wireless. The relationship of client and server arises by virtue of computer programs or other programming running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

As an example, the ECU or controller described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable processor may form part of an engine management system such as an ECU.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claim.

1. A method comprising:
determining a hot side temperature boundary condition and a cool side temperature boundary condition for part of a cylinder of an engine;
mapping the hot side temperature boundary condition for the part of the cylinder to reflect a thermal energy contribution of a combustion event;
running a finite element heat transfer model to calculate a first temperature of a first node of a plurality of nodes positioned between the hot side temperature boundary and the cool side temperature boundary; and
compensating, based on the calculated first temperature, one or more engine operation parameters, the compensating resulting in a change to fuel efficiency and/or engine knocking.

2. A method as in claim 1, wherein the hot side comprises a combustion chamber at least partially contained within the cylinder.

3. A method as claim 1, wherein the cool side comprises one or more of a cylinder block into which heat from the combustion event is dissipated.

4. A method as in claim 1, wherein the cool side temperature boundary condition is determined using one or more of a direct metal temperature sensor and a liquid temperature sensor.

5. A method as in claim 1, wherein the first node is located along a cylinder wall of the combustion chamber.

6. A method as in claim 1, wherein the engine operation parameter includes one or more of a spark timing, a quantity of fuel delivered, a throttle position, and a coolant flow rate.

7. A method as in claim 1, wherein the engine operation parameter includes a quantity of fuel delivered to the combustion chamber that is reduced when the first temperature is warmer than a steady state temperature.

8. A method as in claim 1, wherein the engine operation parameter includes spark advance that is advanced when the first temperature is cooler than a steady state temperature.

9. A method as in claim 1, wherein the engine operation parameter includes spark advance that is delayed when the first temperature is hotter than a steady state temperature.

10. A method as in claim 1, wherein the finite element model is one dimensional and arranged radially.

11. A method as in claim 10, wherein the finite element model accounts for multiple engine materials.

12. A method as in claim 1, wherein the finite element model is multi-dimensional and arranged along components of interest.

13. A method as in claim 12, wherein the finite element model accounts for multiple engine materials.

14. An engine comprising:
a cylinder;
an engine controller comprising a programmable processor, the engine controller configured to perform operations comprising:
determining a hot side temperature boundary condition and a cool side temperature boundary condition for part of the cylinder;
mapping the hot side temperature boundary condition for the part of the cylinder to reflect a thermal energy contribution of a combustion event;
running a finite element heat transfer model to calculate a first temperature of a first node of a plurality of nodes positioned between the hot side temperature boundary and the cool side temperature boundary; and
compensating, based on the calculated first temperature, one or more engine operation parameters, the compensating resulting in a change to fuel efficiency and/or engine knocking.

15. An engine as in claim 14, wherein the hot side comprises a combustion chamber at least partially contained within the cylinder.

16. An engine as in claim 14, wherein the engine further comprises a cylinder block, the cylinder block including the cool side into which heat from the combustion event is dissipated.

17. (canceled)

18. (canceled)

19. An engine as in claim 14, wherein the engine operation parameter includes one or more of a spark timing, a quantity of fuel delivered, a throttle position, and a coolant flow rate.

20. An engine as in claim 14, wherein the engine operation parameter includes a quantity of fuel delivered to the combustion chamber that is reduced when the first temperature is warmer than a steady state temperature.

21. An engine as in claim 14, wherein the engine operation parameter includes spark advance that is advanced when the first temperature is cooler than a steady state temperature.

22. An engine as in claim 14, wherein the engine operation parameter includes spark advance that is delayed when the first temperature is hotter than a steady state temperature.

23. (canceled)

24. (canceled)

25. (canceled)

26. (canceled)

27. A computer program product comprising a machine-readable medium encoding instructions that, when executed by at least one programmable processor, cause the at least one programmable processor to perform operations comprising:
determining a hot side temperature boundary condition and a cool side temperature boundary condition for part of the cylinder;
mapping the hot side temperature boundary condition for the part of the cylinder to reflect a thermal energy contribution of a combustion event;
running a finite element heat transfer model to calculate a first temperature of a first node of a plurality of nodes positioned between the hot side temperature boundary and the cool side temperature boundary; and
compensating, based on the calculated first temperature, one or more engine operation parameters, the compensating resulting in a change to fuel efficiency and/or engine knocking.
